(19) United States
(12) Patent Application Publication
(10) Pub. No.: US 2008/0050201 A1
(43) Pub. Date: Feb. 28, 2008

(54) ANTI-THEFT TACK

(76) Inventors: Franklin H. Valade, Lake Worth, FL (US); Thang Tat Nguyen, Boca Raton, FL (US)

Correspondence Address: Tyco Fire & Security, One Town Center Road, Boca Raton, FL, 33486-1010, US

(21) Appl. No.: 11/467,428

(22) Filed: Aug. 25, 2006

(51) Int. Cl. F16B 15/00

(52) U.S. Cl. 411/455

(57) ABSTRACT

A system, apparatus and method are described for an anti-theft tack having non-snag grooves. The anti-theft tack may be for a security tag, such as an electronic article surveillance security tag. Other embodiments are described and claimed.

### RELATED APPLICATIONS

This application is related to the U.S. patent application entitled “Magnetically Releasable Electronic Article Surveillance Tag,” which is a continuation-in-part of PCT patent application number—PCT/US2005/041813 filed on Nov. 16, 2005 and which is being filed concurrently herewith, both applications of which are incorporated by reference in their entireties for all purposes.

### BACKGROUND

An Electronic Article Surveillance (EAS) system is designed to prevent unauthorized removal of an item from a controlled area. A typical EAS system may comprise a monitoring system and one or more security tags. The monitoring system may create a surveillance zone at an access point for the controlled area. A security tag may be fastened to the monitored item, such as a garment or article of clothing. If the monitored item enters the surveillance zone, an alarm may be triggered indicating unauthorized removal of the monitored item from the controlled area.

Security tags are typically attached to an article of clothing using a tack having a large head and a shank with grooves. During attachment operations, the tack shank may be inserted through the clothing fabric and into a tack shank hole in the security tag. Therein, a locking means of the security tag engages a groove of the tack shank and thereby securely retains the tack.

During this insertion, sharp edges of the grooves tend to snag the fibers of the clothing fabric through which it is inserted. Snagging can cause permanent, visible damage to the cloth. With the development of advanced micro-fibers, retailers may be more sensitive to this damage.

However, the sharp edges of the grooves may result in a more secure engagement with the locking means, increasing the difficulty of forcibly removing the tack from the security tag.

Thus, there may be a need for an improved tack that minimizes damage to clothing fabric or other material through which its shank is inserted, yet may be securely retained by a security tag.

### BRIEF DESCRIPTION OF THE DRAWINGS

FIG. 1 illustrates a perspective view of a tack for use with a security tag, in accordance with one embodiment.

FIG. 2 illustrates a side view of a tack for use with a security tag, in accordance with one embodiment.

FIG. 3 illustrates a partial side view of a shank of a tack for use with a security tag, in accordance with one embodiment.

FIG. 4 illustrates a partial side view of a shank of a tack and tool blades of a tool for forming shank grooves, in accordance with one embodiment.

FIG. 5 illustrates a partial side view of a shank of a tack for use with a security tag, in accordance with one embodiment.

FIG. 6 illustrates a tack, security tag, and article in an unfastened position, in accordance with one embodiment.

FIG. 7 illustrates a tack, security tag, and article, with the tack shank of the tack extended through the article, in accordance with one embodiment.

FIG. 8 illustrates a damaged portion of an article as a result of tack snagging.

FIG. 9 illustrates a damaged portion of another article as a result of tack snagging.

FIG. 10 illustrates a damaged portion of a another article as a result of tack snagging.

FIG. 11 illustrates a damaged portion of another article as a result of tack snagging.

FIG. 12 illustrates a damaged portion of another article as a result of tack snagging.

FIG. 13 illustrates a tack, security tag, and article in a fastened position, in accordance with one embodiment.

FIG. 14 illustrates an interior portion of a security tag with a wedge of a tack retaining system engaged with a tack in the locked condition, in accordance with one embodiment.

### DETAILED DESCRIPTION

Some embodiments may be directed to a tack, which may be used with a security tag. The tack may comprise, for example, a head and a shank. The shank may have one or more grooves and may be arranged to extend through a portion of an item to be monitored, such as an article or garment of clothing, and into a security tag. Within the security tag, the shank grooves may engage a locking means, such as a tack retaining system, of a security tag to secure the tack and article thereto.

Various embodiments may be directed to a security system or portion thereof. The security system may comprise, for example, an EAS system. The EAS system may include a security tag and tack, a detaching device, and a monitoring system. In general operation, the security tag may include a sensor to emit a detectable signal when it is in the monitored surveillance zone. The security tag may be attached to an item to be monitored, such as a garment or article of clothing. The detaching device may remove the security tag from the item. The monitoring system may monitor a controlled area for the signal to ensure that the monitored item with the security tag is not removed from the controlled area.

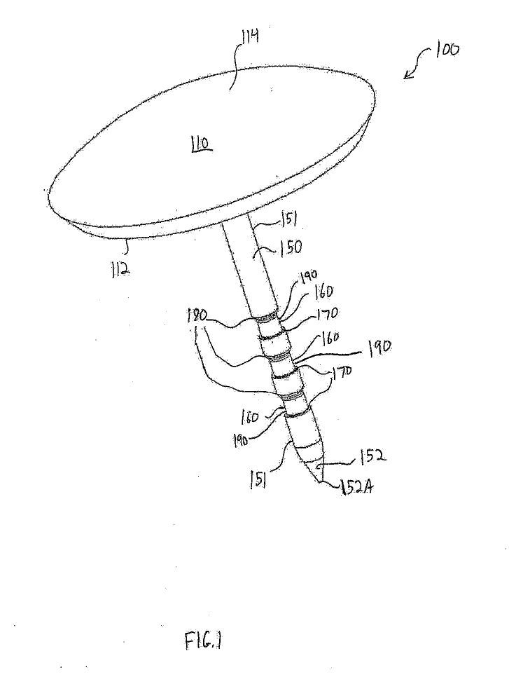

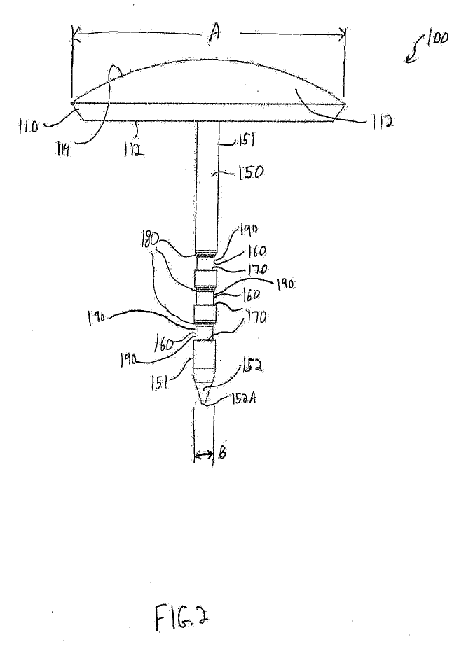

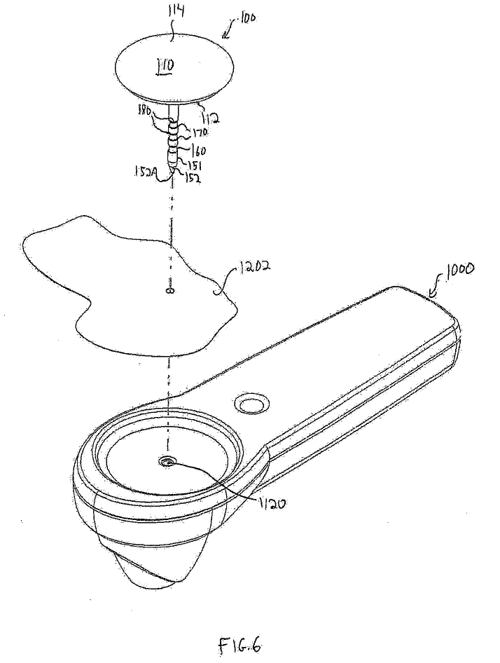

FIGS. 1 and 2 illustrate a perspective and side view, respectively, of a tack 100 for use with a security tag, such as any of the security tag 1000 embodiments described with respect to FIGS. 6-7 and 13-14 below, in accordance with one embodiment. Tack 100 may include a tack head 110 and a tack shank 150 having one or more grooves 160.

Tack 100 may be made of one or more materials, such as one or more of any plastic and/or metal. For example, in an embodiment, tack head 110 of tack 100 is made of plastic and/or steel, while tack shank 150 is made of hardened or unhardened steel. Tack head 110 may be made of plastic or non-magnetic stainless steel to reduce the overall magnetic material of tack 100 in an embodiment where tack 100 is employed with a security tag having a sensor whose range is reduced by such magnetism.

Tack head 110 may be enlarged and have a flat bottom surface 112 and convex top surface 114. Tack head 110 may be otherwise shaped in various other embodiments, such as with a concave bottom surface 112 and/or a flat top surface 114, with or without ribs in the bottom surface 112 and/or elsewhere, or with any other shape. Tack head 110 may have a width A that is wider than the width B of tack shank 150. In one embodiment, tack head 110 has a width A that is an outer diameter of approximately 0.5 inches, and a thickness of approximately 0.05 inches, though these dimensions may be different in other embodiments.

Tack shank 150 may extend from bottom surface 112 of tack head 110 to tack end 152. In one embodiment, tack shank 150 is an elongated member having an at least partially cylindrical outer surface 151 and a tapered tack end 152. Tack shank 150 may be similar in shape to a small pointed nail. In one embodiment, outer surface 151 has a tapered tack end 152 that terminates in a rolled point 152A. In other embodiments, these elements 151, 152, and 152A may be differently shaped. For example, in various embodiments, point 152A may be one of a ground point, cut point, formed point, or other point. The point may be deburred or otherwise refined in one embodiment.

Tack shank 150 may include one or more grooves 160. For example, in one embodiment, tack shank 150 includes three grooves 160. Each groove 160 may be a recessed portion delineated by a leading groove wall 170, trailing groove wall 180, and groove floor 190 that extends between leading and trailing groove walls 170 and 180, respectively. Leading groove wall 170 may be the first of the walls 170 and 180 of groove 160 to pass through an article to be secured when tack 100 is inserted through the article, such as shown and described with respect to the embodiments of FIGS. 6-7 and 13. Trailing groove wall 180 may be the second of walls 170 and 180 to move through the article.

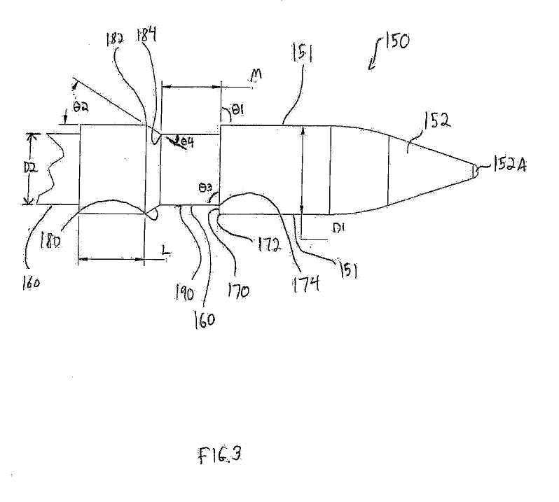

FIG. 3 illustrates a side view of a portion of tack shank 150 of tack 100, in accordance with one embodiment. In this embodiment, grooves 160 are spaced apart by a portion of outer surface of length L and each groove floor 190 extends between leading and trailing wall bottom edges 174 and 184 (described below) at length M. For example, length L may be approximately 0.9 mm and length M may be approximately 0.8 mm, though these lengths may be different in other embodiments.

In one embodiment, groove 160 is recessed such that its groove floor 190 bounds a cylindrical portion of tack shank 150 having a diameter less than that of the cylindrical portion of tack shank 150 bounded by outer surface 151. For example, in one embodiment, the cylindrical portion bounded by outer surface 151 has a diameter of D1 of approximately 1.2 mm, while that of groove floor 190 has a diameter D2 of approximately 0.95 mm. In other embodiments, these dimensions may be different.

For each groove 160, leading groove wall 170 may have a different shape than that of groove wall 180, such that groove 160 is asymmetrical, such as shown in the embodiment of FIG. 3. Leading groove wall 170 may form a leading wall top edge 172 where leading groove wall 170 intersects outer surface 151 of tack shank 150, and a leading wall bottom edge 174 where leading groove wall 170 intersects groove floor 190 of groove 160. Trailing groove wall 180 may have a trailing wall top edge 182 where trailing groove wall 180 intersects outer surface 151 of tack shank 150, and a trailing wall bottom edge 184 where trailing groove wall 180 intersects groove floor 190 of groove 160.

In this embodiment, the angle θ1 formed at leading wall top edge 172 between leading groove wall 170 and outer surface 151 may be greater than the angle θ2 between trailing wall top edge 180 and outer surface 151. Leading wall top edge 172 may thus be considered “sharper” than trailing wall top edge 182. In one embodiment, θ1 is approximately 90° and θ2 is approximately 32°. In other embodiments, θ1 may be otherwise greater than θ2 such that leading wall top edge 172 is sharper than trailing wall top edge 182.

Angle θ3 formed at leading wall bottom edge 174 between leading groove wall 170 and groove floor 190 may be greater than θ4 formed at trailing wall bottom edge 184 between trailing groove wall 180 and groove floor 190. Thus, leading wall bottom edge 174 may be sharper than trailing wall bottom edge 184.

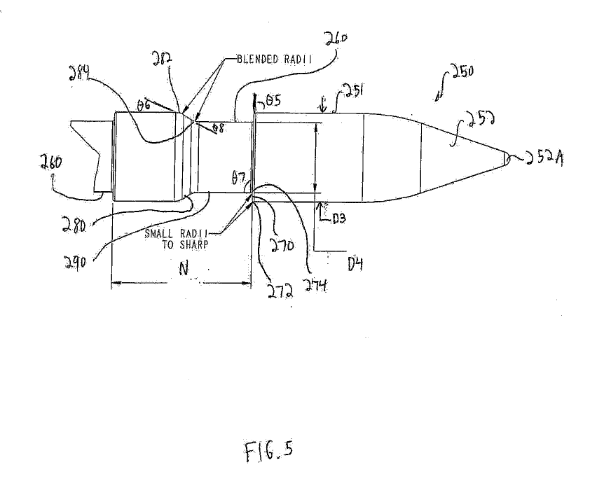

In an embodiment, leading wall top and bottom edges 172 and 174 are respectively sharper than trailing wall bottom edges 182 and 184. For example, in various embodiments, groove floor 190 and outer surface 151 bound cylinders having coincident central axes such that θ1 is approximately equal to θ3, and θ2 is approximately equal to θ4, and θ1, θ3 are greater than θ2, θ4. In one such embodiment, θ2 and θ4 are less than approximately 90° and thus their adjacent, trailing groove wall 180 is considered “sloped” herein, whereas θ1 and θ3 are approximately 90° such that their adjacent, leading groove wall 170 is considered not sloped or “unsloped.” These definitions of “sloped” and “unsloped” apply whether any of the leading and trailing wall top or bottom edges are rounded off, such as shown in and described with respect to FIG. 5 below.

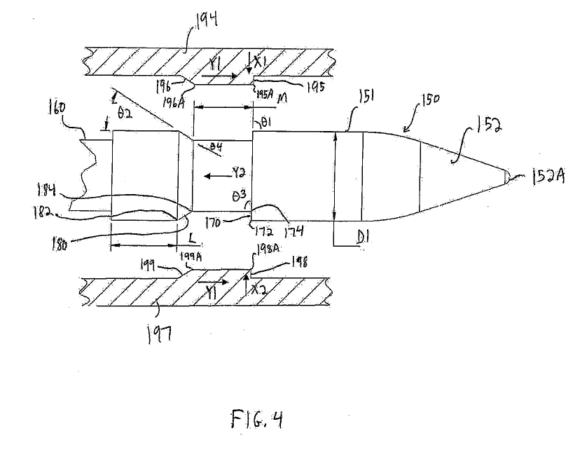

FIG. 4 illustrates a partial side view of a shank 150 of a tack 100 and tool blades 194 and 197 of a material-shaping machine or other tool for forming the shank grooves 160 in shank 150, in accordance with one embodiment.

Tool blades 194 and 197 may respectively have cutting sides 195 and 198 with relatively sharper cutting edges 195A and 198A and opposing sides 196 and 199 with less sharp opposing edges 196A and 199A. These sides 195, 196 and 198, 199 and their respective edges 195A, 196A and 198A, 199A may conform or somewhat conform to leading and trailing groove walls 170 and 180, respectively. Having an asymmetrical groove 160 may thus facilitate the manufacturing process, such as described below, where a material-shaping machine having tool blades each having different shaped sides is used.

When forming each groove 160, tool blades 194 and 197 may be positioned close to or in contact with shank 150 of tack 100. Tool blades 194 and 197 may then form groove 160 by contacting shank 150 while moving back and forth in opposite directions. In one embodiment, this movement of tool blades 194 and 197 may impart frictional forces onto shank 150, causing shank 150 to rotate about its central axis. The forming of each groove 160 by movement of tool blades 194 and 197 may displace the material of shank 150, which may thereby lengthen shank 150.

In one embodiment, tool blade 194 moves in a direction perpendicular or close to perpendicular to both of the directions X1 and Y1. This direction of movement of tool blade 194 may be tangential or close to tangential to outer surface 151. During the movement of tool blade 194, tool blade 197 may move in the direction opposite that of tool blade 194. Tool blades 194 and 197 may then reverse their directions of movement, and may do so simultaneously or close to simultaneously in an embodiment. This process may be repeated such that tool blades 194 and 197 move back and forth along substantially parallel paths, but in opposite directions. Tool blades 194 and 197 may, by their movements, impart forces in directions X1 and X2, respectively, and also in the direction opposite Y1, onto shank 150 to form groove 160. Trailing groove wall 180 of the groove 160 that is being formed may impart opposing forces in the Y1 direction onto tool blades 194 and 197, which may result in sides 195 and 198 of tool blades 194 and 197, respectively, imparting forces in the Y1 direction onto leading groove wall 170. These forces onto leading groove wall 170 may provide definition to leading groove wall 170 during the forming process and may hone leading wall top and bottom edges 172 and 174, respectively.

In an embodiment of tack 100 having shank 250, such as described with respect to FIG. 5 below, tool blades 194 and 197 may be shaped to form grooves 260 in shank 250. In another embodiment, tool blades 194 and 197 shaped as shown in FIG. 4 may be used to form shank 150, and then one or more of edges 172, 174 of leading groove wall 170 and 182, 184 of trailing groove wall 180 may be rounded off with another material-shaping machine to form shank 250 with corresponding edges 272, 274 of leading groove wall 270 and 282, 284 of trailing groove wall 280.

In other embodiments, shank 150 and/or 250, including their respective grooves 160 and/or 260, respectively, may be formed using other manufacturing methods. For example, in various embodiments, shank 150 and/or 250 may be formed by a stamping process, or by using a screw machine or lathe, or by other methods and/or by use of other machines or tools.

FIG. 5 illustrates an embodiment of a tack shank 250 that may be used as the tack shank for the tack 100 described with respect to FIGS. 1 and 2, for example. Tack shank 250 may include elements 251, 252, and 252A that correspond to elements 151, 152, and 152A of tack shank 150 described with respect to FIGS. 1-3.

Tack shank 250 may include one or more asymmetrical grooves 260. For example, in one embodiment, tack shank 150 includes three grooves 260 (only one and part of a second are shown). Each groove 260 may be a recessed portion delineated by a leading groove wall 270, trailing groove wall 280, and groove floor 290 that extends between leading and trailing groove walls 270 and 280, respectively. Dimensions D3 and D4 may correspond to dimensions D1 and D2, respectively, of tack shank 150 as shown in and described with respect to FIG. 3. The length N between like portions of grooves 260 or outer surface 151 portions between grooves 260 may be approximately 1.9 mm, or other lengths in other embodiments. Tack shank 150 of FIG. 3 may also have a length corresponding to length N of approximately 1.9 mm, or other lengths in other embodiments.

For each groove 260, leading and trailing groove walls 270 and 280, respectively, may be differently shaped such that groove 260 is asymmetrical. In one embodiment, leading and trailing groove walls 270 and 280 of groove 260 may correspond to leading and trailing groove walls 170 and 180 of groove 160, and angles θ5-θ8 may correspond of θ1-θ4, respectively. However, in this embodiment, one or both edges of one or both of leading and trailing groove walls 270 and 280 may be rounded off (unlike those of leading and trailing groove walls 170 and 180) such that they meet at a curve, which may have one or a blend of more than one radius.

Thus, for example, in one embodiment, leading groove wall 270 may form leading wall top and bottom edges 272 and 274 that respectively correspond to leading wall top and bottom edges 172 and 174 of tack 150, except that leading wall top and bottom edges 272 and 274 are rounded off.

In another embodiment, trailing groove wall 280 may form trailing wall top and bottom edges 282 and 284 that respectively correspond to trailing wall top and bottom edges 182 and 184 of tack 150, except that trailing wall top and bottom edges 282 and 284 are rounded off.

In another embodiment, any combination of edges 272, 274 of leading groove wall 270 and edges 282, 284 of trailing groove wall 280 are rounded off.

In another embodiment, edges 272, 274 of leading groove wall 270 and/or edges 282, 284 of trailing groove wall 280 are rounded off with radii so large the radii overlap. In this embodiment, there may thus be no flat portion of leading groove wall 170 and/or trailing groove wall 180, such that the entirety of leading groove wall 170 and/or trailing groove wall 180 is curved. In other embodiments, the entirety of either or both leading and trailing groove walls 170 and 180, respectively, is curved as a spline, a complex curve, or other curve. In this and the other embodiments of grooves 160 and 260, the shapes described may be approximate such that roughness, pits, and/or other shapes that may be formed due to inherent manufacturing variances or from use are excluded in defining the shapes of grooves 160 and 260 and components thereof.

In the embodiments, angles θ5-θ8 are taken with respect to non-rounded portions of leading and trailing groove walls 270 and 280. In one such embodiment, and such as described above with respect to θ1-θ4 of tack shank 150, groove floor 290 and outer surface 251 of tack shank bound cylinders having coincident central axes such that 05 is approximately equal to θ7, and θ6 is approximately equal to θ8, and θ5, θ7 are greater than θ6, θ8. In one such embodiment, θ6 and θ8 are less than approximately 90° and thus their adjacent, trailing groove wall 280 is considered “sloped,” whereas θ5 and θ7 are approximately 90° such that their adjacent, leading groove wall 270 is considered “unsloped” as that term applies herein, notwithstanding the rounded off leading top and/or bottom edges 272, 274. Thus, as shown from FIG. 5, leading or trailing groove wall 270 and 280 may have a straight portion between any rounded off (where applicable) edges 272, 274 or 282, 284 with may angle θ5, θ7 or θ6, θ8, respectively, of less than 90°, and thus be sloped, or of approximately 90°, and thus be unsloped.

FIG. 6 illustrates a tack 100, security tag 1000, and an article 1202 (or portion thereof) to be secured in an unfastened position, in accordance with one embodiment. In this embodiment, security tag 1000 may correspond to one of the security tags described in the U.S. patent application entitled “Magnetically Releasable Electronic Article Surveillance Tag,” which is being filed concurrently herewith and is incorporated by reference in its entirety.

The article to be secured may comprise any commercial good, such as any of a garment, article of clothing, packaging material, boxes, and so forth. When the article is a garment or article of clothing, tack end 152 may be inserted through the garment and into security tag 1000 through tack shank hole 1120.

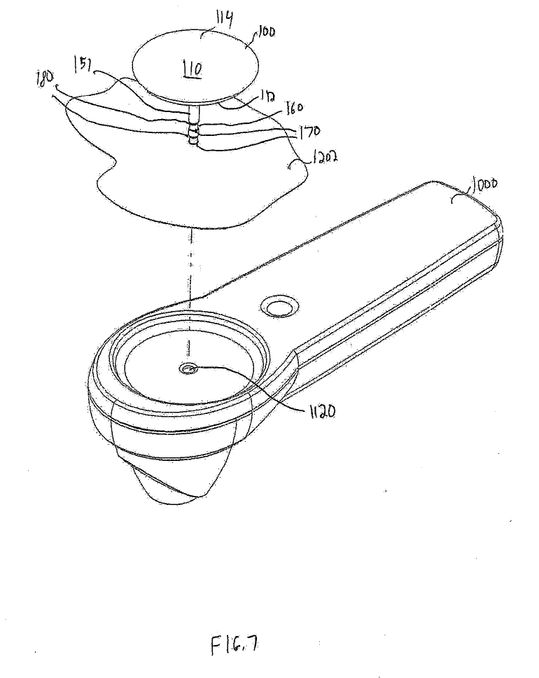

FIG. 7 illustrates a tack 100, security tag 1000, and article 1202 to be secured, with the tack shank 150 of the tack 100 extending through article 1202, in accordance with one embodiment. The tack shank 150 may be extended through the article 1202 by forcing tack end 152 through the article 1202. In an embodiment where the article 1202 is clothing or another item having fibers, tack end 152 may push apart the fibers to create an aperture in article 1202. By using a tack 150 having a tack shank 152 with one or more grooves 160 having “sloped” (versus unsloped) trailing groove walls 180, for example, the trailing wall top edges 182 may gradually separate the fibers as they pass through article 1202, forming a hole, causing little or no snagging (and thus damage) to the fibers. The tack 100 may be pulled out through the hole as well without causing much more, if any fiber damage. The grooves 160 may each have leading wall top edges 172 that are rounded off, which may result in less or no snagging during the pullout.

In one embodiment, grooves 160 are sloped with angles θ2 that are considerably less than 90°, which may result in less snagging than with angles θ2 (as in FIG. 3) closer to 90°. For example, in one embodiment, angle θ2 is approximately 32°, although the angle may be different in other embodiments.

In a tack 100 embodiment including tack shank 250 with grooves 260 having rounded off trailing wall top edges 282 such as described with respect to FIG. 5 above, such a configuration may contribute to reducing or eliminating snagging damage as well.

In other embodiments of a tack 100 with either shank 150 or 250 of FIG. 3 or 5, respectively, corresponding trailing groove wall 180 or 280 may be another shape that may reduce or eliminate snagging. For example, in one embodiment, trailing groove wall 180 or 280 may be shaped as a spline such that trailing groove wall 180 and 280 is sloped between its edges 182, 184 or 282, 284, while leading groove wall 170, 270 is unsloped or nearly unsloped.

In another embodiment of tack 100, either shank 150 of FIG. 3 or shank 250 of FIG. 5 may respectively have one or more grooves 160 or 260 each shaped such that its trailing groove wall 180 or 280 extends between groove floor 190 or 290 and outer surface 151 or 251 at a more gradually changing angle than that of leading groove wall 170 or 270. In this embodiment, the largest angle between any portion of trailing groove wall 180 or 280 with respect to groove floor 190 or 290 and outer surface 151 or 251 is less than the largest angle between any portion of leading groove wall 170 or 270 with respect to groove floor 190 or 290 and outer surface 151 or 251. In one embodiment, trailing groove wall 180 or 280 may more gradually change its angle as compared to leading groove wall 170 or 270 such that trailing groove wall 180 or 280 has more surface area than that of leading groove wall 170 or 180.

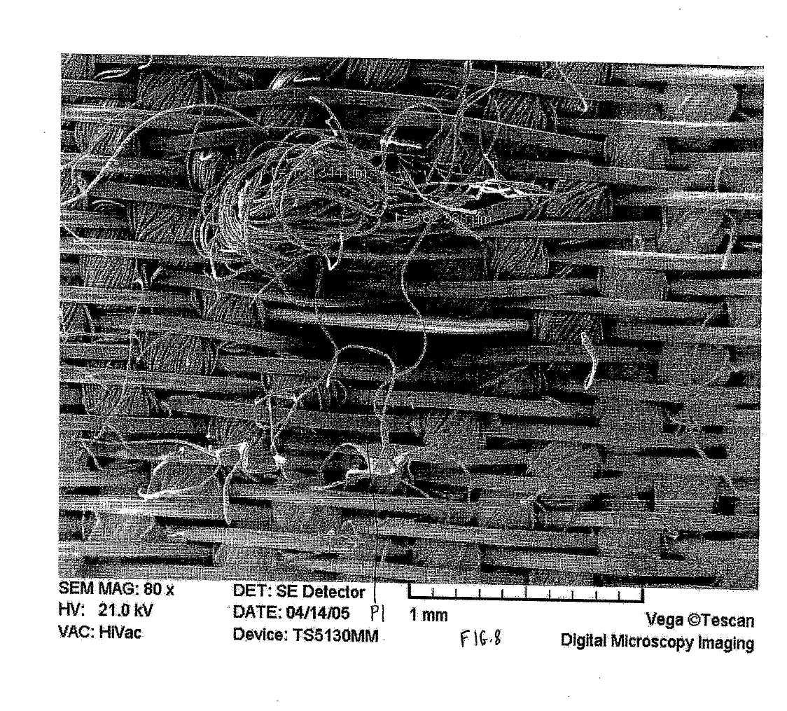

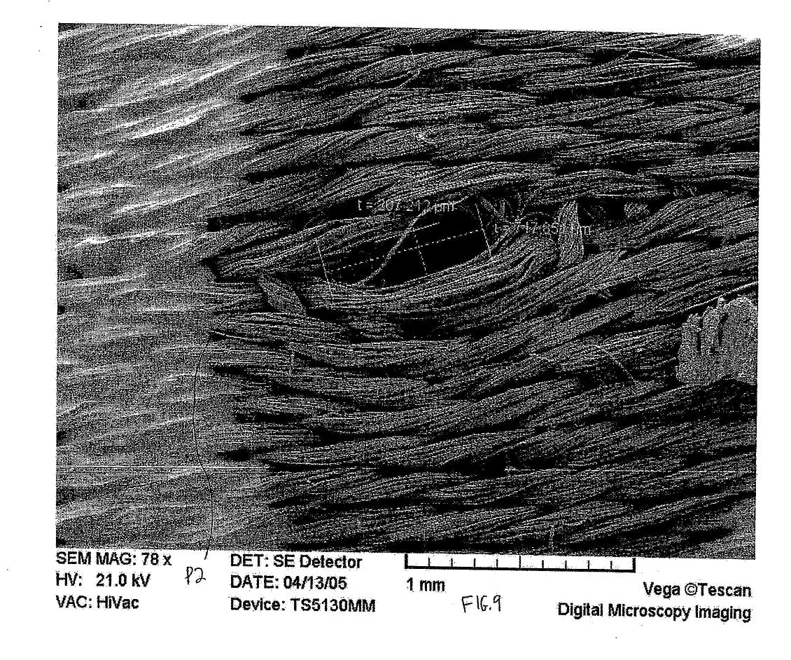

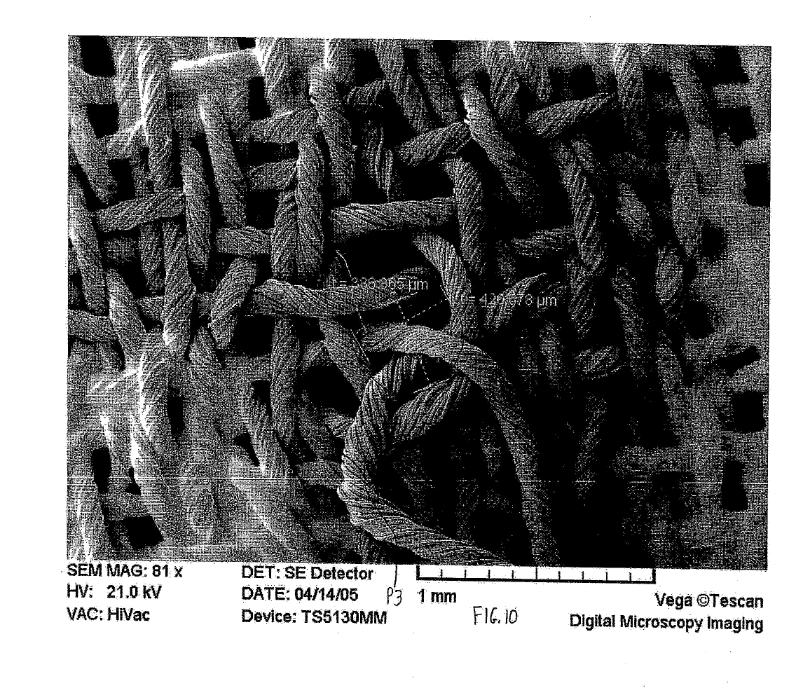

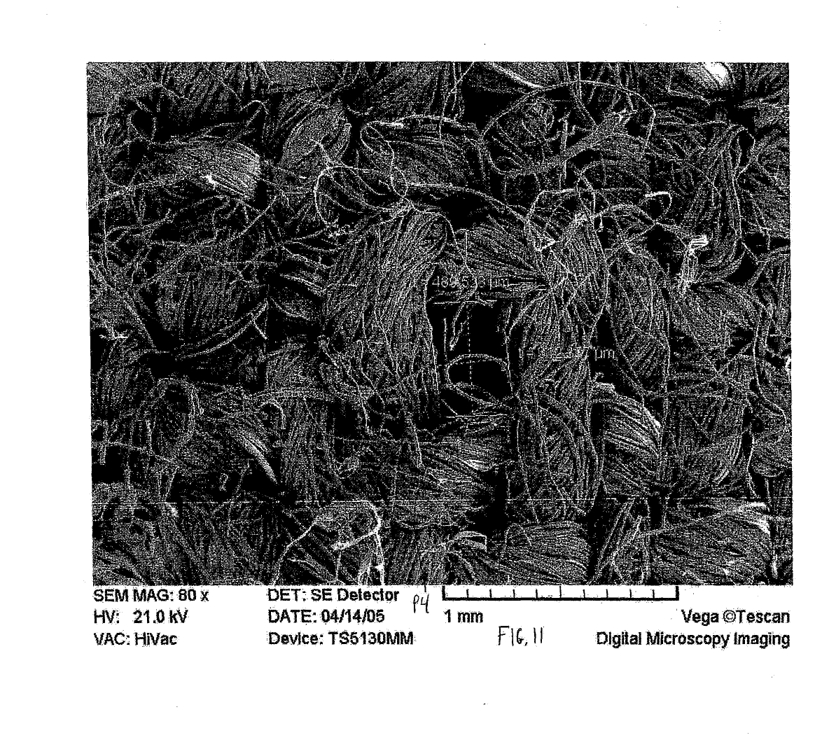

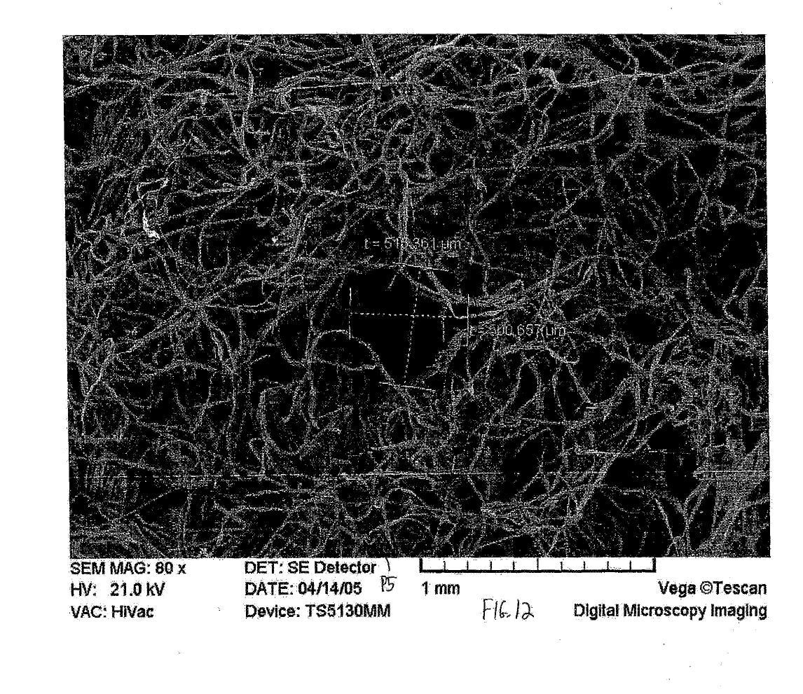

FIGS. 8-12 provide examples of damaged portions of article fibers as a result of snagging by existing tacks, which the tack embodiments of the present invention may lessen or avoid. In each example, an existing tack with a tack shank having grooves with unsloped trailing groove walls and sharp trailing wall top edges has been inserted through the article and then removed. The resultant damage is in portions P1-P5 in FIGS. 8-12, respectively, where fibers have been broken apart, pulled, and/or otherwise snagged. It may be desired to avoid such visible damage to the article.

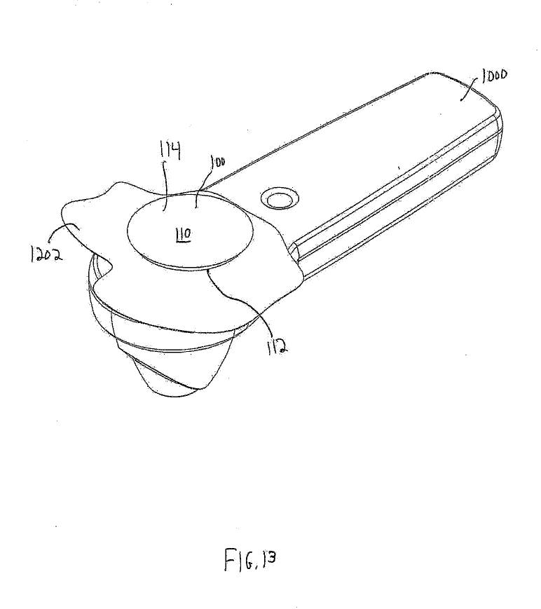

FIG. 13 illustrates a tack 100, security tag 1000, and article 1202 in a fastened position, in accordance with one embodiment. In this embodiment, the tack 100 is extended through the article 1202 and further into the security tag 1000. The tack 100 may engage a wedge (not shown) of a tack retaining system (not shown) in a “locked condition,” such as shown and described with respect to one or more embodiments of a tack retaining system and associated wedge, whether reusable or for one-time use, in the concurrently-filed “Magnetically Releasable Electronic Article Surveillance Tag” application referenced above.

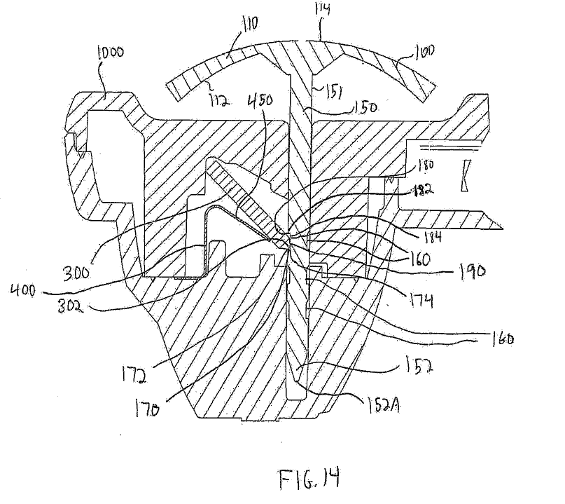

For example, FIG. 14 shows an interior portion of security tag 1000 with a wedge 300 of a tack retaining system engaged with tack 100 in the locked condition, in accordance with one embodiment. The tack retaining system may include a wedge 300 and a biasing member 400. Biasing member 400 may bias the tack retaining portion 302 of wedge 300, such as by a cantilevered spring or other biasing portion 450, into engagement with a groove 160 of tack 100 in the locked condition to secure tack 100 to security tag 1000. The tack retaining portion 302 of wedge 300 may, in the locked condition, engage groove 160 by extending into groove 160 and being positioned adjacent groove floor 190 and leading groove wall 170. Leading groove wall 170 may have a leading wall top edge 172 that is sharper than that of trailing wall top edge 182 of trailing groove wall 180. In one embodiment, leading groove wall 170 may be not sloped, such that its angles (corresponding to θ1 and θ3 of FIG. 3) are approximately 90°. Having a relatively sharp leading wall top edge 172 and/or an unsloped leading groove wall 170 may provide more resistance to disengaging wedge 300 from leading groove wall 170 (and thus out of the locked condition) without use of a magnetic detacher, versus a less sharp leading wall top edge 172 and/or sloped leading groove wall 170.

In other embodiments, different tack retaining systems may be employed in security tags 1000. In these embodiments, the tack retaining system may include one or more wedges, rotating or other clamps, and/or one or more other elements that may each be urged, such as by rotation and/or translation by any type of spring and/or other biasing member, at least partially into one of the grooves 160 to block movement of tack 100 out of security tag 1000, thus forming the locked condition. The tack retaining system may be disengaged from the locked condition by magnetic, non-magnetic, mechanical, electromechanical, another means, or a combination of any of the aforementioned means, such as a means for rotating and/or translating the one or more aforementioned elements out of the locked condition.

For example, in various embodiments, the tack retaining system may include one or more of a ball clutch having any number of balls (e.g. three in one embodiment), a spring clamp, another element, or some combination of the aforementioned elements such that at least a portion of the element or elements extend into at least one groove 160 to form the locked condition.

As described above, the tack 100 of one or more embodiments herein may provide leading groove walls and edges that result in less or no snagging when inserted through an article with fibers, such as microfibers for example, and trailing groove walls and edges that may provide a desired defeat resistance against an unauthorized attempt to remove the tack from a security tag.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A tack for a security tag, comprising:
a head; and
a shank to extend from the head, the shank including one or more asymmetrical grooves.

2. The tack of claim 1, wherein each of the one or more asymmetrical grooves includes a leading groove wall and a trailing groove wall, the trailing groove wall being sloped.

3. The tack of claim 2, wherein the trailing groove wall comprises a trailing wall top edge, the trailing wall top edge being rounded off.

4. The tack of claim 2, wherein the trailing groove wall comprises a trailing wall bottom edge, the trailing wall bottom edge being rounded off.

5. The tack of claim 2, wherein the leading groove wall comprises a leading wall top edge, the leading wall top edge being rounded off.

6. The tack of claim 2, wherein the leading groove wall comprises a leading wall bottom edge, the leading wall bottom edge being rounded off.

7. The tack of claim 1, wherein each of the one or more asymmetrical grooves includes a leading groove wall and a trailing groove wall, the leading groove wall being unsloped.

8. The tack of claim 7, wherein the trailing groove wall comprises a trailing wall top edge, the trailing wall top edge being rounded off.

9. The tack of claim 7, wherein the trailing groove wall comprises a trailing wall bottom edge, the trailing wall bottom edge being rounded off.

10. The tack of claim 7, wherein the leading groove wall comprises a leading wall top edge, the leading wall top edge being rounded off.

11. The tack of claim 7, wherein the leading groove wall comprises a leading wall bottom edge, the leading wall bottom edge being rounded off.

12. The tack of claim 1, wherein each of the one or more asymmetrical grooves comprises a leading groove wall including a leading wall top edge and also comprises a trailing groove wall including a trailing wall top edge, the leading wall top edge being sharper than the trailing wall top edge.

13. The tack of claim 1, wherein each of the one or more asymmetrical grooves comprises a leading groove wall including a leading wall bottom edge and also comprises a trailing groove wall including a trailing wall bottom edge, the leading wall bottom edge being sharper than the trailing wall bottom edge.

14. The tack of claim 1, wherein each of the one or more asymmetrical grooves includes a leading groove wall having a leading wall bottom edge and also includes a trailing groove wall having a trailing wall bottom edge, the leading wall bottom edge being sharper than the trailing wall bottom edge.

15. The tack of claim 1, wherein the one or more asymmetrical grooves comprise three asymmetrical grooves.

16. The tack of claim 1, wherein the security tag is to include a tack retaining system, one of the one or more asymmetrical grooves to engage the tack retaining system in the locked condition.

17. The tack of claim 16, wherein the tack retaining system is to include a wedge having a tack retaining portion, the one of the one or more asymmetrical grooves to engage the tack retaining system in the locked condition by engaging the tack retaining portion of the wedge.

18. The tack of claim 16, wherein the tack retaining system is to include a ball clutch.

19. The tack of claim 16, wherein the tack retaining system is to include a spring clamp.

20. The tack of claim 16, wherein the tack retaining system is to include a biasing member.

21. The tack of claim 16, wherein the biasing member is to include a spring.

22. The tack of claim 1, wherein each of the one or more asymmetrical grooves includes a leading groove wall, the entirety of the leading groove wall being curved.

23. The tack of claim 1, wherein each of the one or more asymmetrical grooves includes a trailing groove wall, the entirety of the trailing groove wall being curved.

24. The tack of claim 1, wherein the shank further includes an outer surface, each of the one or more asymmetrical grooves includes a leading groove wall and a trailing groove wall, and the largest angle between any portion of the trailing groove wall and the outer surface is less than the corresponding largest angle between any portion of the leading groove wall and the outer surface.

25. The tack of claim 1, wherein each of the asymmetrical grooves includes a leading groove wall and a trailing groove wall, and the trailing groove wall has more surface area than the leading groove wall.

26. The tack of claim 1, wherein the shank has a tack end having a rolled point.

27. The tack of claim 1, wherein the shank has a tack end having a ground point.

28. The tack of claim 1, wherein the shank has a tack end having a cut point.

29. The tack of claim 1, wherein the shank has a tack end having a formed point.

30. A tack for a security tag, the tack comprising a shank having one or more asymmetrical grooves, each of the one or more grooves comprising:
means for engaging a wedge of a tack retaining system of the security tag in a locked condition; and
means for reducing or eliminating snagging of fibers of an article as the shank of the tack is moved through the article.
